(19) United States
(12) Patent Application Publication
(10) Pub. No.: US 2013/0133591 A1
(43) Pub. Date: May 30, 2013

(54) STOP PULLING HARNESS

(71) Applicant: Theresa G. Silva, Star, ID (US)

(72) Inventors: Theresa G. Silva, Star, ID (US); Trevor Lambert, Zimmerman, MN (US); Dan Fulford, Royalton, MN (US); Michael Store, St. Paul, MN (US)

(73) Assignee: Theresa G. Silva, Star, ID (US)

(21) Appl. No.: 13/747,784

(22) Filed: Jan. 23, 2013

Related U.S. Application Data
(63) Continuation-in-part of application No. 13/076,256, filed on Mar. 30, 2011.
(60) Provisional application No. 61/396,241, filed on May 24, 2010.

(51) Int. Cl. A01K 27/00

(52) U.S. Cl. CPC A01K 27/003
USPC 119/793

(57) ABSTRACT

The present disclosure is for an adjustable leash that can quickly and easily be converted to a restraining harness that helps to inhibit the unwanted movement of the dog or other animal walking on the leash. In some embodiments, the leash is adjustable without the use of any tools and can be adapted to fit quadrupeds of a variety of sizes.

### CROSS REFERENCE TO RELATED APPLICATIONS

This application is a continuation-in-part of application Ser. No. 13/076,256 which in turn claims priority under 35 USC §119 to U.S. Provisional Patent Ser. No. 61/396,241, filed on May 24, 2010, and is titled “STOP PULLING HARNESS.” The entire contents of both are hereby incorporated by reference.

### BACKGROUND

1. Technical Field

The present disclosure relates to restraint devices for quadruped animals. More particularly, the present disclosure relates to an adjustable leash that is easily adapted to restraining a quadruped, such as a dog, from excessively pulling or straining when walked on a leash.

2. Background

Various drawbacks exist for many types of existing harnesses and leashes for animals such as dogs or other quadrupeds. For example, leashes that attach solely to a collar, or other types of neck or head worn harnesses, if improperly used can cause injury and harm to the animal wearing the leash. Another drawback of existing body-worn harnesses is that they are relatively expensive and difficult to put on.

Another drawback of existing leashes and harnesses is that some quadrupeds, dogs in particular, are prone to try and lunge, run, tug, or strain against the leash. This is a more acute drawback when the dog is of a large, powerful breed and the person holding the leash is relatively small or overmatched compared to the dog. In this scenario, the dog ends up dragging or pulling the person along behind which is not a desirable or enjoyable result for the person, and is detrimental to the discipline and training of the dog. Other drawbacks also exist.

Therefore, it is desirable to provide a relatively inexpensive and easy to use leash or harness that it easy to use and obviates many of the known drawbacks of existing products. It is further desirable, to provide a leash or harness that helps to inhibit a dog, or other animal, from lunging or straining against the leash.

### SUMMARY

The present disclosure advantageously addresses one or more of the aforementioned deficiencies by providing an adjustable leash that can quickly and easily be converted to a restraining harness that helps to inhibit the unwanted movement of the dog or other animal walking on the leash. In some embodiments, the leash is adjustable without the use of any tools and can be adapted to fit quadrupeds of a variety of sizes.

In one embodiment, the adjustable leash can be attached to a collar or other harness and function as a normal leash or lead when walking a dog or other quadruped. In the event the dog or other quadruped displays undesirable behavior (e.g., lunging, or tugging against the leash) the free end of the leash can be passed through a loop forming junction (e.g., a ring or other connector) to form a loop in the leash that encircles the dog's or other quadruped's body in a region near the hind legs. Further undesirable behavior by the dog or quadruped will result in tightening or cinching of the loop around the body, and in turn causing mild discomfort to the animal that discourages the undesirable behavior.

In another embodiment, the leash is adjustable so that the loop forming junction (e.g., ring) may be positioned in a desirable location on the dog's or other quadruped's body. In some embodiments, a desirable location on the dog is adjacent to the hind legs of the animal. On male dogs or quadrupeds, the location of the loop forming junction may be adjusted to not interfere with, or cause pain in, the animal's reproductive organs. In some embodiments, the portions of the leash that encircle or contact the animal's body may be padded for additional comfort or protection against injury, while still delivering the tightening or cinching to curb the undesirable behavior.

In another embodiment the leash is adjustable to fit differing sizes of dogs or other quadruped. In this fashion, a person owning more than one dog of differing sizes or breeds can adjust the leash to fit any number of animals.

The present disclosure will now be described more fully with reference to the accompanying drawings, which are intended to be read in conjunction with both this summary, the detailed description, and any preferred or particular embodiments specifically discussed or otherwise disclosed. This disclosure may, however, be embodied in many different forms and should not be construed as limited to the embodiments set forth herein; rather, these embodiments are provided by way of illustration only so that this disclosure will be thorough, and fully convey the full scope of the invention to those skilled in the art.

### BRIEF DESCRIPTION OF THE DRAWINGS

FIG. 1 is an exemplary depiction of an embodiment of the invention in use as a restraint on a dog or other quadruped.

FIG. 2 is an exemplary depiction of an embodiment of the invention in use as a leash on a dog or other quadruped.

FIG. 3A is an exemplary depiction of ring embodiment of a loop forming junction according to some embodiments of the invention.

FIG. 3B is an exemplary depiction of a D-ring embodiment of a loop forming junction according to some embodiments of the invention.

FIG. 3C is an exemplary depiction of a triangular ring embodiment of a loop forming junction according to some embodiments of the invention.

FIG. 4 is an exemplary depiction of another embodiment of a loop forming junction according to some embodiments of the invention.

FIG. 5 is an exemplary depiction of an embodiment of a leash employing the loop junction of FIG. 4 in accordance with some embodiments of the invention.

FIG. 6 is an exemplary depiction of an embodiment of a restraint employing the loop junction of FIG. 4 in accordance with some embodiments of the invention.

FIG. 7 is an exemplary depiction of a floating ring and stopper embodiment of a loop forming junction in accordance with some embodiments of the invention.

FIG. 8 is an exemplary depiction of a limited floating ring loop forming junction in accordance with some embodiments of the invention.

### DETAILED DESCRIPTION

In the following description, reference is made to the accompanying drawings that form a part thereof, and in which is shown by way of illustration specific exemplary embodiments in which the invention may be practiced. These embodiments are described in sufficient detail to enable those skilled in the art to practice the invention, and it is to be understood that modifications to the various disclosed embodiments may be made, and other embodiments may be utilized, without departing from the spirit and scope of the present invention. The following detailed description is, therefore, not to be taken in a limiting sense.

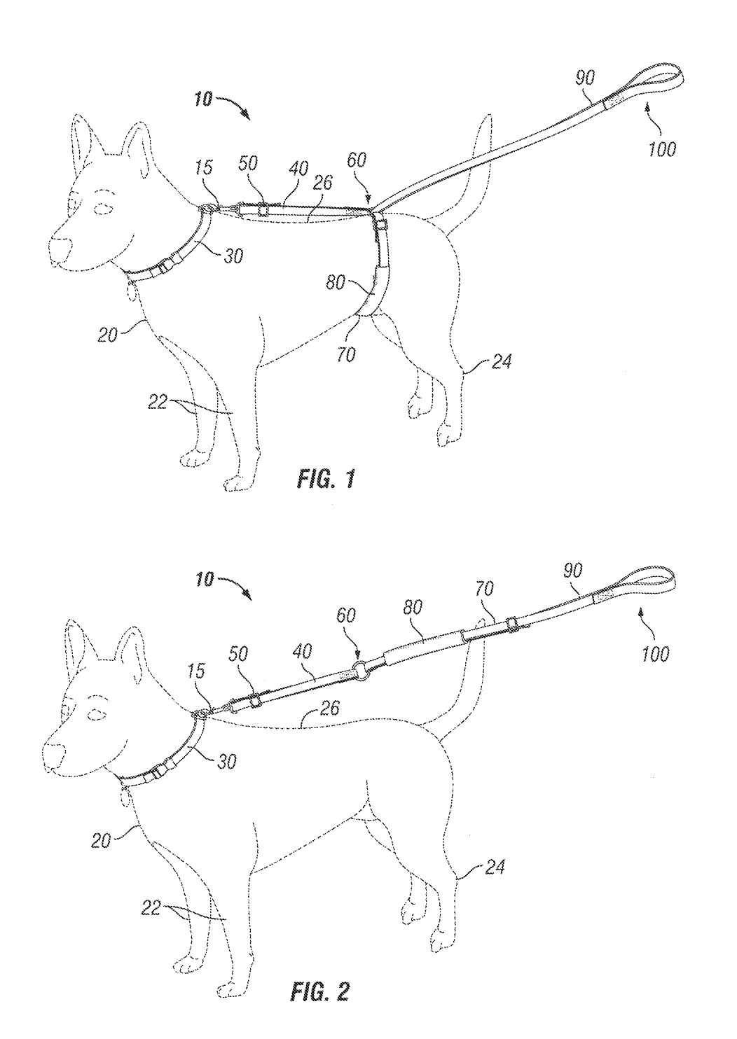

With reference to FIG. 1, the adjustable leash is shown generally at 10. As shown, the adjustable leash 10 has an end 15 that is releasably attachable to a collar or other harness 30 that is worn by a dog or other quadruped animal 20. In some embodiments, end 15 may include a clasp, hook, latch, buckle, or other releasable fastener that can attach to an appropriate eyelet or ring on the collar or other harness 30. In other embodiments, it may be desirable to make the collar 30 integral with end 15, for example, by fashioning an adjustable loop or the like that would fit around the neck, shoulders, or forelegs 22, of the dog or animal 20.

Further, while dog or other quadruped 20 animal is generally depicted in FIG. 1 as a canine, the disclosure is not so limited. The adjustable leash 10 may be used with any animal for which control by leash or harness is appropriate, and further, the animal need not be a quadruped.

In some embodiments, adjustable leash 10 may be constructed out of cord or cord-like material. For example, adjustable leash 10 may be constructed out of flat or tubular webbing material, rope, cord, straps, woven material, linked or chain material, wire, cable, or other relatively flexible cord-like material. In some embodiments, the adjustable leash 10 may be constructed out of Nylon, plastics, rubbers, or other synthetic materials. In other embodiments, the adjustable leash 10 may be made out of natural materials such as leather, natural fibers, metals (including alloys), or the like.

As also shown in FIG. 1, end 15 is part of a first portion 40 of the adjustable leash 10. First portion 40 may be adjustable in length through use of an appropriate adjustment mechanism 50 such as a double or triple slide, D-rings, buckles, snaps, buttons, hook-and-loop fasteners, or other cord adjustment mechanisms. In some embodiments, one or more adjustment mechanisms 50 may be used, alone or in combination, to adjust the position of loop forming junction 60. In some embodiments, adjustment mechanism 50 is employed to position loop forming junction 60 at or near the hind legs 24 of the dog or other quadruped 20, and generally along the spine or back 26 of the dog or other animal 20.

As further shown in FIG. 1, first portion 40 connects with a loop forming junction 60. In some embodiments, loop forming junction 60 may comprise a ring or other similar device that facilitates the formation of a loop in the adjustable leash 10.

As illustrated with reference to FIG. 2, when not configured as a restraining harness, adjustable leash 10 functions as a normal leash, in that it is attached to the dog or other quadruped 20 via a collar or other harness 30 and grasped at a free end 100 by the person walking the dog or other quadruped 20. Of course, free end 100 is at the end of a second portion 90 of the adjustable leash 10 and may have a loop, handle, or other mechanism to facilitate the grasping and control of the adjustable leash 10. When it is desired to configure the adjustable leash 10 into a restraining harness, the free end 100 of the second portion 90 is wrapped around the dog or other quadruped 20 at a region at or near the hind legs 24. The free end 100 is then passed through the loop forming junction 60 in order to snuggly fit around the dog or other quadruped 20 as shown with reference to FIG. 1. Any undesirable behavior by the dog or other quadruped 20 (e.g., lunging, running, tugging, or straining against the adjustable leash 10) causes the loop portion 70 to tighten or cinch around the body of the dog or other quadruped 20 and discourages the undesirable behavior.

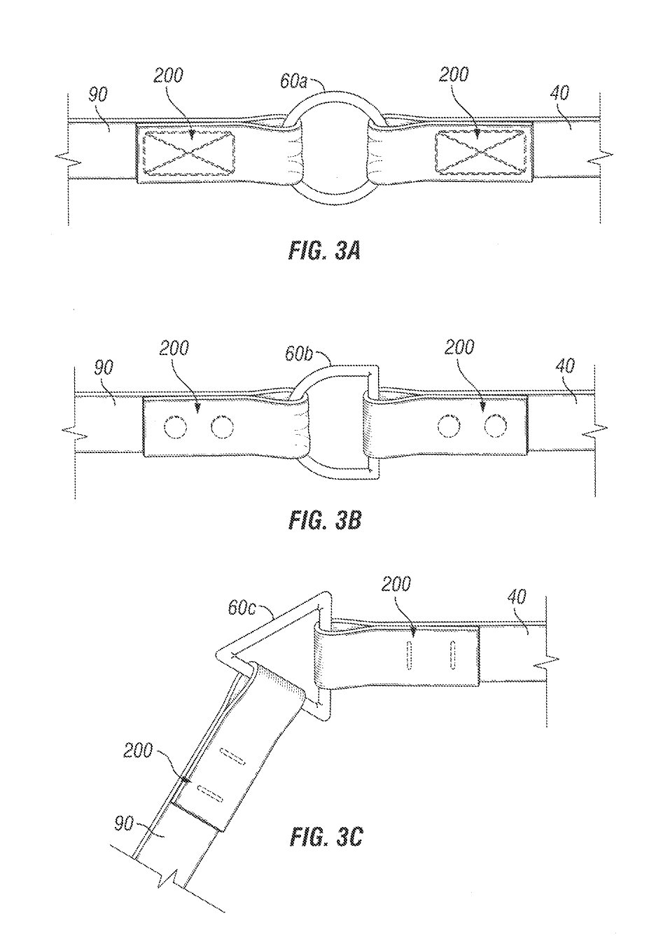

As depicted in FIGS. 1 and 2, the first portion 40 and second portion 90 of the adjustable leash 10 meet at loop forming junction 60. As described above, the loop forming junction 60 facilitates the forming of a loop, using loop portion 70, around the body of the dog or other quadruped 20. Loop forming junction 60 may be manufactured in any appropriate manner from a material suitable to handle the anticipated stresses and loading on the leash 10. For example, and with reference to FIGS. 3A-3C, loop forming junction 60 may comprise a metal ring 60a, a D-ring 60b, a triangular shaped ring 60c, or some other appropriately shaped junction point.

As also illustrated in FIGS. 3A-3C, the loop forming junction 60 may be securely fastened to the first portion 40 of the leash 10, as well as fixed end of the second portion 90 of the leash 10, by any appropriate method as indicated at 200. For example, the material of first portion 40 may be folded and sewed, glued, melted, welded, or otherwise fastened using mechanical fasteners (e.g., staples, crimps, or the like). The method of fastening may vary according to factors such as the materials used or the strength desired.

As described herein, one function of the loop forming junction 60 is to enable the forming of a loop using loop portion 70 of the leash 10. Thus, it is possible to implement any combination of shapes, materials, and coatings, or the like, that facilitate the feeding through of free end 100 and the motion of second portion 90 as it tightens or cinches upon tension. For example, for a leash 10 made of round profile cord-like material (e.g., rope), a circular ring (such as 60a) made of steel or the like may perform best for forming a cinchable loop, whereas with flat profile cord-like material (e.g., Nylon webbing) a triangular shaped ring (such as 60c) may perform best. In addition, knurled surfaces, silicone or Teflon coatings, or vinyl or similar covers may be implemented in loop forming junction 60 to facilitate the operation of the loop portion 70. Thus, for example, if the cord-like material slides too easily through the loop forming junction 60, knurling or coatings may be added to increase friction. Conversely, if the material does not slide easily, coatings or vinyl covers may be added to decrease friction. Other solutions, such as mechanical features (e.g., a locking gate, or the like, built into the junction 60) are also possible.

Likewise, the material used to make loop forming junction 60 can vary depending upon the nature of the intended use. In some embodiments, steel or other metal junction rings 60 are desirable (e.g., when large forces are expected). In other embodiments, plastic, or other synthetic materials may be implemented (e.g., when lower manufacturing costs are desirable, or for use in wet environments where metals may rust).

In some embodiments it may be advantageous to pad or otherwise soften the loop portion 70 where it contacts the dog or other quadruped 20. This may be accomplished in any suitable fashion, for example, by including a positionable pad 80, or by constructing the loop portion 70 of the leash 10 out of softer, more elastic, or otherwise padded material 80. One object of padding portion 80 of the leash 10 is to minimize or prevent injury to the dog or other quadruped. Other padding configurations are also possible.

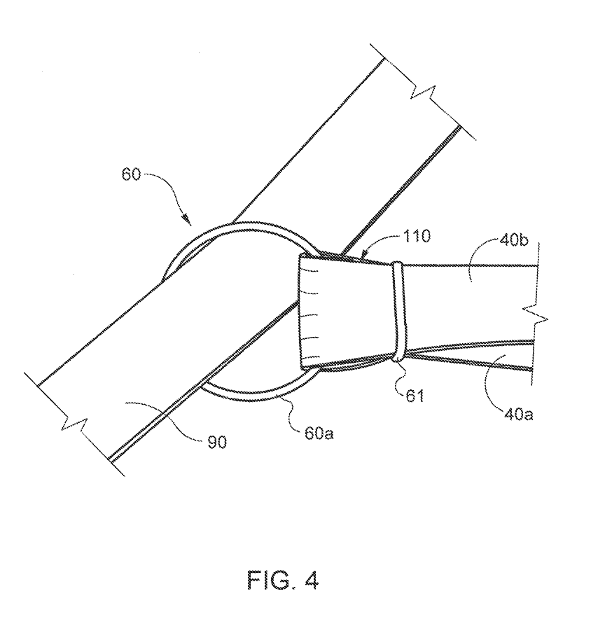

FIG. 4 is an exemplary depiction of another embodiment of a loop forming junction 60 according to some embodiments of the invention. In such embodiments, loop forming junction 60 may be formed using a ring 60a and a positionable cinch 61. While ring 60a and cinch 61 are depicted respectively as generally circular and oval, other shapes are also possible. In addition, other positionable cinches 61, such as clamps, buckles, or the like, may be used.

In such embodiments, cinch 61 encircles a fold 110 formed by segment 40a and 40b of first portion 40. Fold 110 passes through ring 60a and the ring 60a may be held in position by sliding cinch 61 closer to the ring 60a. In this manner, the length of first portion 40 may be adjusted in order to position the loop forming junction 60 at an appropriate position on the animal 20. Loop portion 70 may be formed by passing the free end 100 of the second portion 90 through ring 60a.

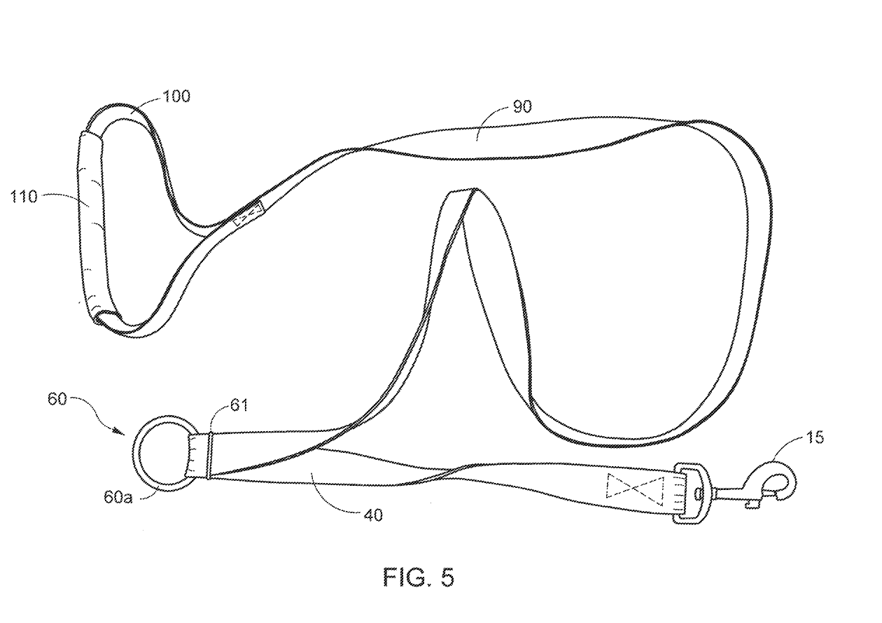

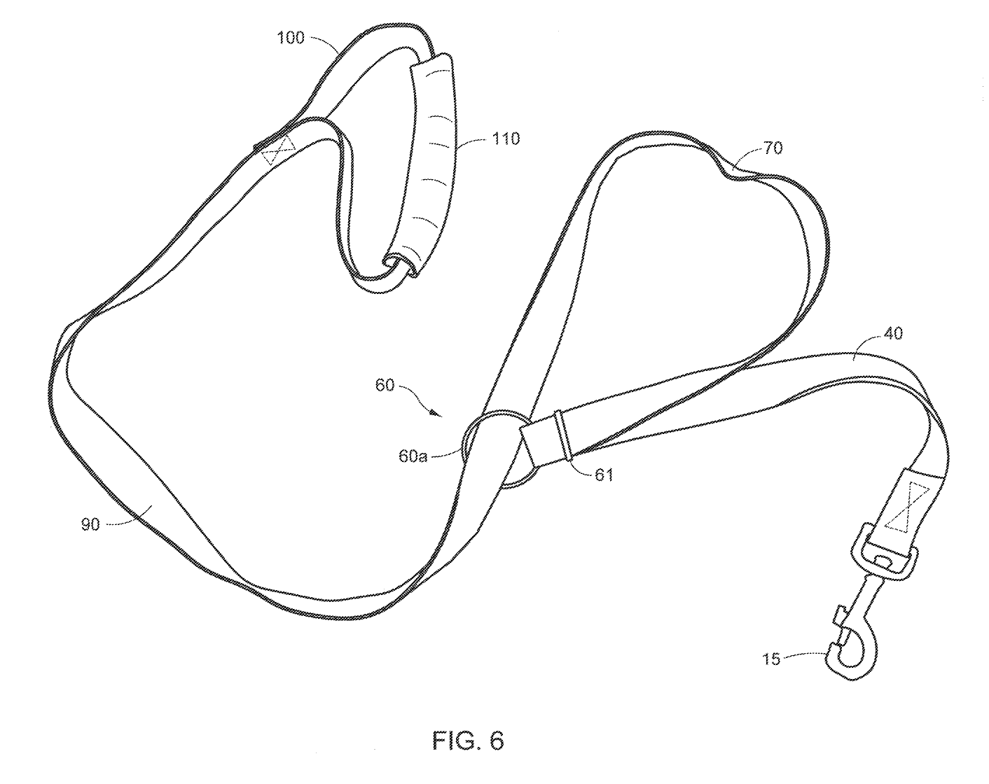

FIG. 5 is an exemplary depiction of an embodiment of a leash employing the loop forming junction 60 of FIG. 4 in accordance with some embodiments of the invention. As shown, loop forming junction 60 may be positioned along first portion 40 and does not significantly affect use as a leash. End 15 may be attached to a collar 30 as described herein and free end 100, which may also include a graspable handle 110 can be held by the person walking the animal 20. Any suitable material may be used for handle 110, such as rubber, foam, plastic, wood, metal, or the like.

FIG. 6 is an exemplary depiction of an embodiment of a restraint employing the loop forming junction 60 of FIG. 4 in accordance with some embodiments of the invention. As shown, free end 100 has been passed through loop forming junction 60 (and ring 60a) to form a loop portion 70 that can be used to encircle, and thereby safely restrain, an animal 20 as described herein. Not shown in FIG. 6 is pad 80 which in some embodiments may also be provided on loop portion 70 to provide additional comfort to the animal 20.

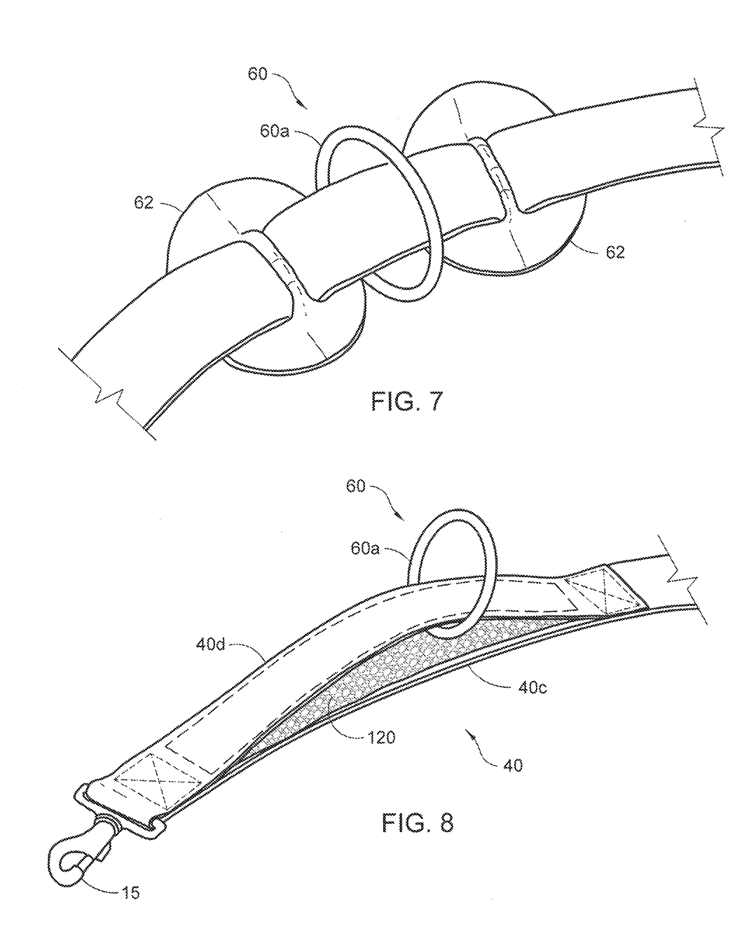

FIG. 7 is an exemplary depiction of a floating ring and stopper embodiment of a loop forming junction 60 in accordance with some embodiments of the invention. As shown for this embodiment, loop forming junction 60 may be formed using a ring 60a that encircles first portion 40 and can be positioned by use of stoppers 62. While shown as a generally circular ring 60a, the invention is not so limited and other shapes can be used.

Stoppers 62 may be formed of any suitable material and configuration that enables slideable or releaseable positioning along first portion 40. For example, stoppers 62 may be buckles that can slide or otherwise be attached to first portion 40 at a variety of locations and to prevent or hinder the ring 60a from further movement along first portion 40. In some embodiments it may be preferable to use multiple stoppers (e.g., two are shown in FIG. 7) to assist in positioning ring 60a at a desired location. Of course, a single, or multiple, stoppers 62 may also be used to position ring 60a.

FIG. 8 is an exemplary depiction of a limited floating ring loop forming junction 60 in accordance with some embodiments of the invention. As shown a loop forming junction may be formed by providing a ring 60a that is positionable between segments 40c and 40d of first portion 40. Segments 40c and 40d may be releaseably fastened together by use of hook-and-loop fasteners 112 (e.g. Velcro®) or other selectively fastenable mechanisms. In these embodiments, segments 40c and 40d may be unfastened and ring 60a may be positioned at the desired location along first portion 40, and then segments 40c and 40d may be re-fastened to hold the ring 60 in place. Again, shapes other than circular may be employed for the ring 60a.

These embodiments are called limited floating due to the fixing of the ends of segments 40c and 40d into place on first portion 40, thus, limiting the extent to which the ring 60a can be positioned along first portion 40. The fixing of the ends of segments 40c and 40d may be accomplished in any suitable manner, such as sewing, gluing, welding, stapling, riveting, or combinations of the foregoing.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the spirit and scope of the present disclosure.

What is claimed is:

1. An adjustable leash comprising:
an adjustment portion in contact with a loop forming junction;
a looping portion having a free end; and
wherein the free end may be passed through the loop forming junction to create a loop in the dog leash that passes substantially around the body of the dog upon which the leash is applied.

2. The adjustable leash of claim 1 wherein the loop forming junction further comprises:
a ring encircling a fold in the adjustment portion, and
a cinch that is positionable along the adjustment portion and cooperates with the fold to position the ring at a desired location.

3. The adjustable leash of claim 2 wherein the cinch is positioned by sliding along the adjustment portion.

4. The adjustable leash of claim 1 wherein the loop forming junction further comprises:
a ring encircling the adjustment portion, and
a stopper that is positionable along the adjustment portion and enables the ring to be positioned at a desired location along the adjustment portion.

5. The adjustable leash of claim 4 wherein the loop forming junction further comprises:
a second stopper that is positionable along the adjustment portion and enables the ring to be positioned at a desired location along the adjustment portion.

6. The adjustable leash of claim 1 wherein the loop forming junction further comprises:
a ring slidablely located between two segments of the adjustment portion, and
a selectablely engagable fastener that fastens the two segments of the adjustment portion in order to position the ring at a desired location.

7. The adjustable leash of claim 6 wherein the selectablely engageable fastener further comprises a hook-and-loop fastener.
